(19) United States
(12) Patent Application Publication
(10) Pub. No.: US 2004/0202742 A1
(43) Pub. Date: Oct. 14, 2004

(54) Continuous foam core laminating machine for construction panels

(76) Inventor: Amos G Winter, Concord, NH (US)

Correspondence Address: MAINE & ASMUS, 100 MAIN STREET, P O BOX 3445, NASHUA, NH, 03061-3445, US

(21) Appl. No.: 10/484,393

(22) PCT Filed: Jul. 23, 2002
(86) PCT No.: PCT/US02/23697

Related U.S. Application Data
(60) Provisional application No. 60/307,236, filed on Jul. 23, 2001.

(51) Int. Cl. B29C 47/02

(52) U.S. Cl. 425/115; 425/817 C; 425/133.5; 425/371

(57) ABSTRACT

An improved conveyor belt laminator for making foam core panels has an internal floating drive mechanism (2, 3), a sliding deckle system (52), a hinged plate front end section (69) to control the rolling bank of foam, hydraulic controls, and is manufacturable from readily available, standard, structural steel components.

### CROSS REFERENCE TO RELATED APPLICATIONS

This application claims priority to U.S. Provisional Patent Application Serial No. 60/307,236, filed 23 Jul. 2001.

### FIELD OF INVENTION

This invention relates to the field of foam core continuous laminators and pressure conveyers, more particularly to foam core continuous panel laminators with sliding side deckle and controlled rise capacity.

### BACKGROUND

Continuous foam laminated products have become increasingly accepted as building materials. As the state of the art advances, certain issues have arisen regarding the manufacture and the design of equipment for the production of foam core laminates.

Such machines generally consist of a pair of oppositely disposed conveyer belts set in such a way that a skin, coated on one side in an expanding foam material, may be fed thorough and forced in contact with a second skin layer. This process generally takes place in a high temperature, high pressure environment. Careful control of the pressures and temperatures must be maintained to prevent damage to either the machine or the product, and for quality assurance.

Past laminating machines use gearboxes and motors mounted externally to the machine. This approach applies unequal torque to opposite sides of the conveyer belts and as between belts, causing stress on the machine, and distorting the foam panel.

Some laminating machines fail to properly support the laminate as it is fed through the machine. This failure often results from flexing of the materials and components used in the conveyer belts, and from improper frame and track design resulting in a lack of support before the belt engages the sprocket on the end of the machine.

A number of issues are related to the rise of the foam once it is applied to the skin. In a restrained rise process, as the liquid foam is applied to the bottom side of the laminator, it immediately starts to expand until it reaches or contacts the top side laminate at the top platens, at which time it starts to extrude back towards the feed end or throat of the laminator. This layer of foam has a ramp- like profile until the point where it starts to extrude. The back wave of the extrusion is called a rolling bank.

The rolling bank is a problem because it distorts the cell structure of the foam. The ideal shape for foam cells is egg shaped. If the second layer of skin is applied immediately, and the laminator presses down on the foam, the cell shape of the foam is distended towards the horizontal, weakening the final product. One possible known solution to these problems is a process called “free rise”. In the free rise process, liquid foam is uniformly distributed on the bottom of the skin or between the two skins and allowed to rise unrestrained by a top molding surface until it reaches approximately the correct thickness. This process has the disadvantage of allowing distortion of the cells towards the vertical, but more importantly, of making the thickness of the panel a matter of estimate, rather than a controlled variable.

The use of platen belts has some draw backs, among these, one is that the platens may improperly align or may separate allowing lines to form on thin skinned foam products. This has been dealt with in a number of ways. One such way is through the use of continuous, flexible belts, in some instances manufactured from stainless steel, which cover or replace the platens.

What is needed is a laminator machine that has moving, molding side restraints, provides uniform torque to the conveyor belt, provides a substantially flat working surface both along and across the conveyor surface, and along and between individual platens of the conveyor belt, provides for the controlled rise of foam to prevent the disadvantages of both rolling bank foam and free rise foam, allows flexibility in the design of the panels produced, and is comparatively simply constructed from readily available, standard materials.

### SUMMARY OF INVENTION

It is among the objects of the invention to provide a continuous laminator machine which has moving molding side restraint, and a uniform drive torque to both sides of its conveyor belts.

It is also among the objects of the invention to provide a laminator which preserves the strength of the foam material by reducing the distortion of foam cells in both uniform and non-uniform panels such as egg crate or corrugated surface designs, a laminator with an angularly adjustable front end section for controlling foam rise and rolling bank, a laminator which produces panels of accurately predetermined thickness, and a laminator that can be constructed from minimally altered, readily available, standard materials.

It is again among the objects of the present invention to provide a laminator in which wear is minimized, where worn components are easily changed, which has means for regulating the temperature of the surface of the conveyer belt, and in which adjustments to its pressure rails are minimized since its frame is machined as a unit.

It is a further goal of the invention to provide a quick change mechanism in the form of a sliding deckle for side molds, and to provide greater durability of such a mechanism than might otherwise be expected.

Still other objects and advantages of the present invention will become readily apparent to those skilled in this art from the following detailed description, wherein only a preferred embodiment of the invention is described, simply by way of illustration of the best mode contemplated for carrying out the invention. As will be realized, the invention is capable of other and different embodiments, and its several details are capable of modifications in various obvious respects, all without departing from the invention.

### BRIEF DESCRIPTION OF THE FIGURES

FIG. 1 is a partially exploded perspective view of the back end right sight of a conveyor belt of a preferred embodiment laminator.

FIG. 2 is a a perspective view of the left side front end of the top and bottom conveyor belt frames of a preferred embodiment, showing the belt carrier tracks with 180 degree circular front end track for reversing the direction of the belts into the throat of the laminator.

FIG. 2A is a perspective view of a circular section taken from the structure of FIG. 2, showing the lower belt pressure rail atop an I beam, and the upper belt carrier and pressure rails incorporated into the lower edge of another I beam, as indicated by placement of an illustrative roller from each of the upper and lower conveyor belt chains.

FIG. 3 is a top side inboard perspective view of the outboard end of two platens of the invention, with the chain link and roller to which the first platen is attached extending forward of the front edge of the first platen, and a sliding deckle extending from the outboard end of the first platen for defining the edge of the laminate product as it is fabricated in the laminator.

FIG. 4 is an underside outboard perspective view of the platens of FIG. 3, showing the chain links and rollers attached to the platens, the cam follower on the underside of the deckle slider, and a mold head mounted on the deckle plate.

FIG. 5 is an upper left side front end perspective view of the frames of a preferred embodiment laminator with center and front end supports shown, the top frame incorporating a hinge plate and hinged front section angularly adjustable for limited closure of the throat opening by lowering the upper frame front end support.

FIG. 6 is a close up side view of the hinged plate mechanism connecting the upper frame hinged front section of FIG. 5 to the main section and permitting large radius bending of the pressure rail.

FIG. 7 is a perspective outboard sideview of a main frame support, with hydraulic cylinder linking the lower frame support leg to the upper frame support leg, and a deckle rail acuator shaft protruding from the frame attachment surface.

FIG. 8 is a section view of the preferred embodiment laminator at the center main frame support, showing the relationship of the conveyor belts on their I beam frames, the side deckle operating mechanism mounted to the lower frame and support legs, and the left and right side cylinder support of the upper frame over the lower frame.

FIG. 9 is a section view of the lower conveyor belt of the embodiment of FIG. 8, at a lookout station between main frame supports, illustrating the additional support provided the deckle rail mechanism by the lookout structures attached to the I beam framework.

FIG. 10 is a perspective outboard sideview of a front end frame support, with hydraulic cylinder linking the lower frame support leg off a pivotal support joint to the upper frame support leg with a ball and socket joint, permitting a limited degree of lowering and tilting of the hinged front end section of the upper conveyor belt.

FIG. 11 is a cross section view of a narrow belt laminator embodiment, the main frame being fabricated of two steel channel beams, and the chain links and rollers configured to ride within the channel beams on the underside portion of the belt path, while platen width exceeds the frame spacing, and with link pins spanning the two chains for engagement with center mounted drive sprockets.

### DESCRIPTION OF THE PREFERRED EMBODIMENT

The laminator of the invention is a comprehensive approach to the several problems identified in the prior art. What follows is a description of a preferred embodiment, incorporating the several features of the invention in a novel combination as a laminator machine. The preferred embodiment laminator is configured with upper and lower conveyor belts consisting fundementally of individual platens attached to the links of left and right side conveyor roller chains which travel on two parallel rails or tracks that are integral to the framework of the machine. The features of the invention occur in the details of the design as will be described below. It will be readily apparent to those skilled in the art that various combinations of all or some of the features are within the scope of the invention in order to provide the desired combination of advantages. Obvious extensions of the invention will be apparent to those skilled in the art. For example, wider or thicker laminates or laminates requiring greater fabrication pressure may require a machine having more than two sets of roller chains and tracks for each belt in order to provide more lines of support for the platens.

Referring to the figures, in a preferred embodiment laminator machine, the twin I beam frame is partially cut away to show how a conveyor belt (not shown in this figure) is driven by floating drive shaft 2 at the back end or discharge end of the machine. Upper and lower conveyor belts are similarly configured but turn in opposite directions. Drive motor/gearbox 3 is incorporated into the conveyor belt system at the center of the drive shaft 2 between drive sprockets 4, rather than outboard of the drive sprockets as is common in the art. The drive shaft 2 floats or slides on pillow blocks 5 so as to provide for a small range of longitudinal movement. Hydraulic pressure in cylinders 6 applied at each drive sprocket 4 keeps uniform tension on each side of the belt. The center mounted motor/gearbox 3 provides uniform torque to each of the sprockets 4, to draw the belts and laminate products through the machine. Torque rods 7 (only one shown) connected to the machine frame carry the weight of the motor/gearboxes 3.

Cordal action is that motion that causes the familiar prior art jiggle or rattle or cyclic variation in chain length as each link of a continuous chain is picked up by the end sprocket teeth. This phenomena is mitigated somewhat in the preferred embodiment by the floating drive-end tensioning mechanism of the suspended drive motor/gearboxes 3, promoting a smoother passage of the belt system and panels through the machine. A hydraulic take up cylinder with a pressure regulator and accumulator work well for cylinder 6.

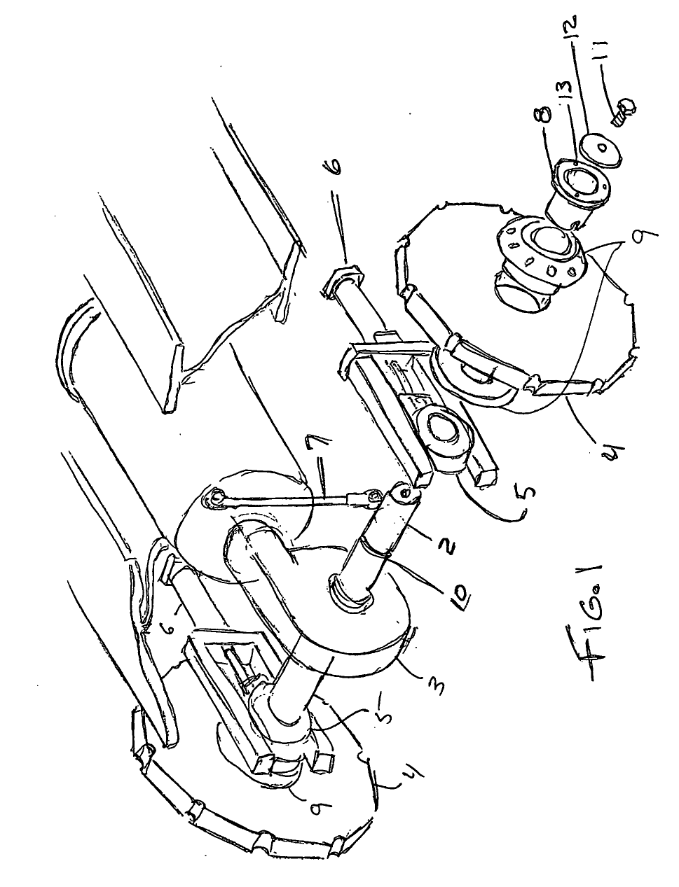

FIG. 1 illustrates the various components of the sprocket drive system in a partially exploded view. Among the components is a collet 8, which is inserted into split hub 9 of sprocket 4. Collet 8 centers hub 9, and positions it against shoulder 10 on shaft 2 upon which the sprocket assembly is disposed. A single bolt 11 threads into the center of shaft 2 through washer 12 to pull collet 8 and sprocket 4 tight on shaft 2. For disassembly, three threaded holes 13 are provided on the flange of collet 8 to provide for pulling the collet once the bolt and washer are removed. The drive sprockets 4 are made of UHMW polyethylene. This reduces wear on chain pins and sprockets 4.

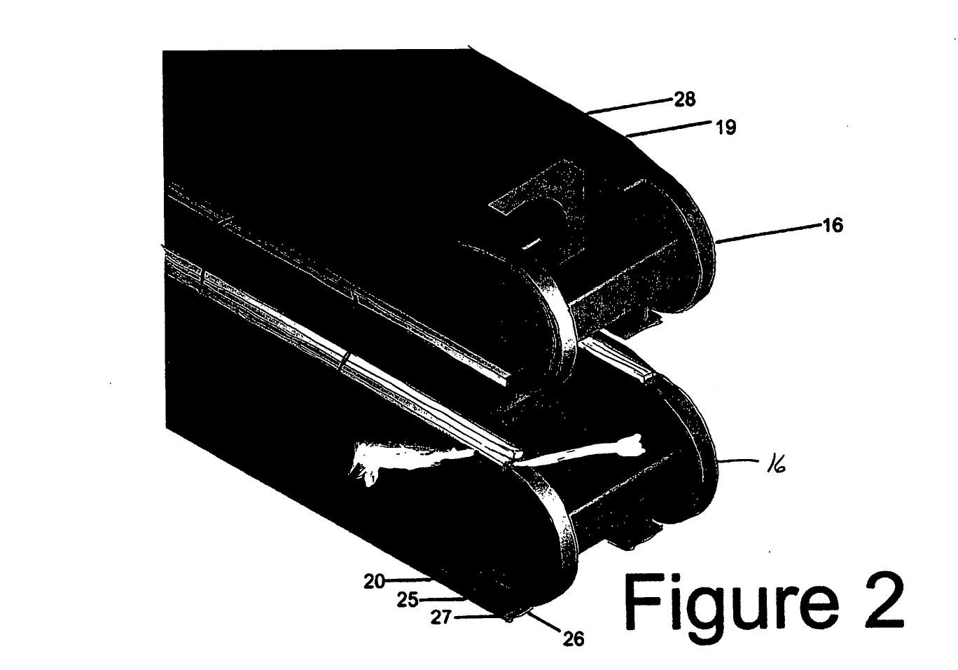

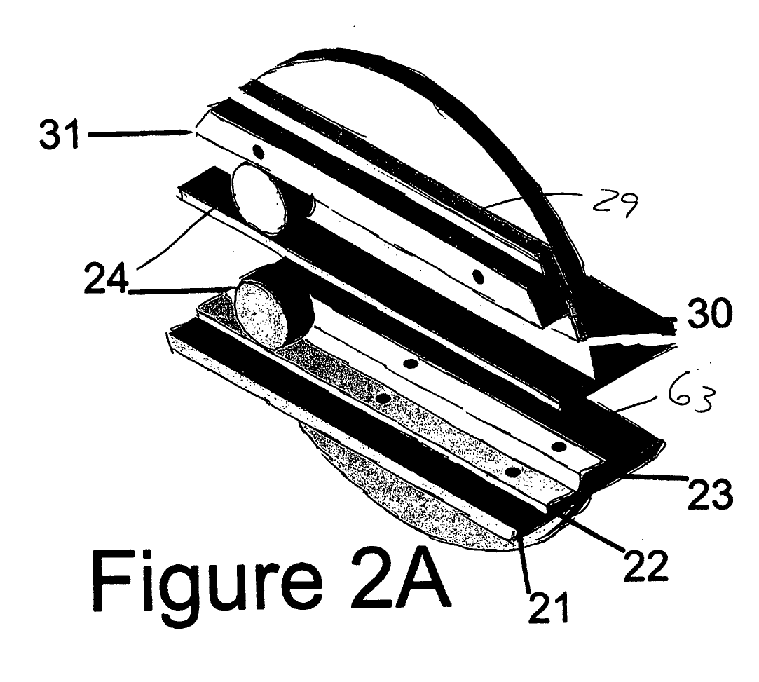

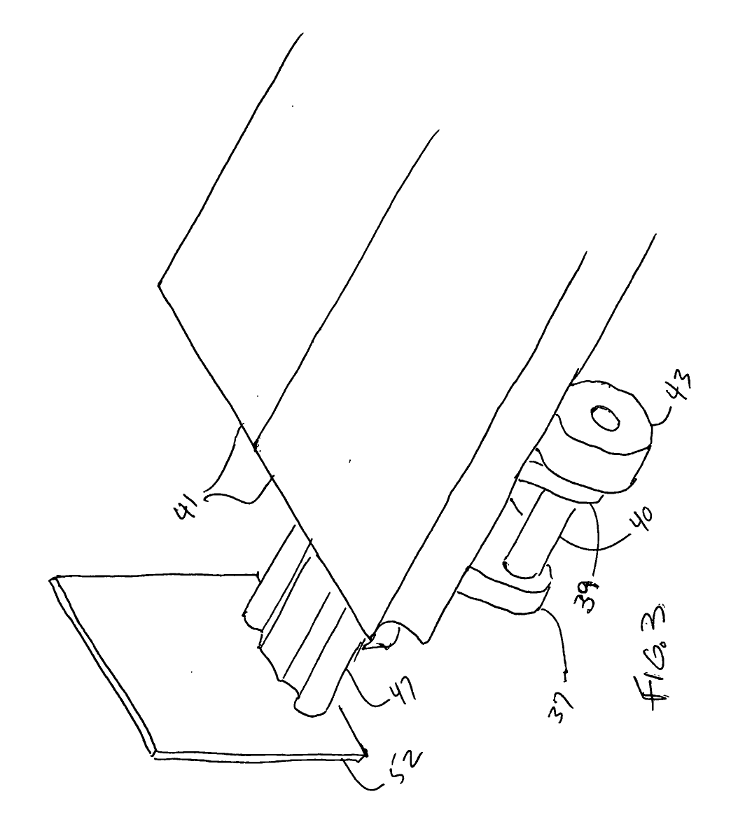

Referring to FIGS. 2 and 3, the front end or feed end of the machine is the idler end with respect to the conveyor belt system. Each side of each conveyer belt 1 has a solid machined radius return 16 on the front end of the machine, on which follower rollers on each chain link ride for the reversal of direction. This is a useful alternative to having an idler sprocket similar to sprocket 4 on the drive end of the machine. It provides a smooth transition into and out of the radial reversing motion to horizontal travel through the laminator. A sprocket here would tend to introduce a slight dip in link motion as the sprocket teeth pulled down and away, as the chain link is picked up on the pressure ways of the conveyor bed.

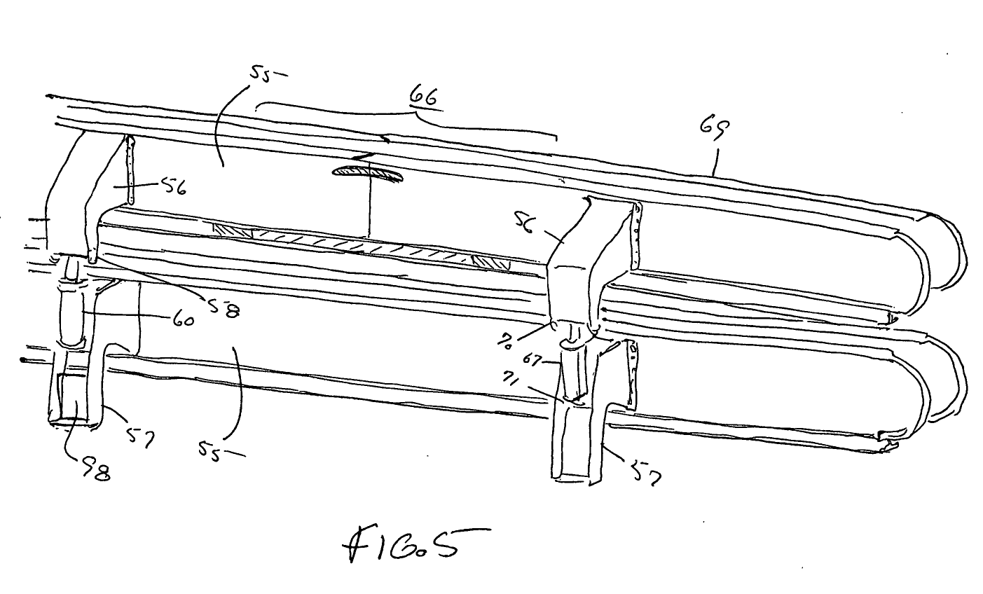

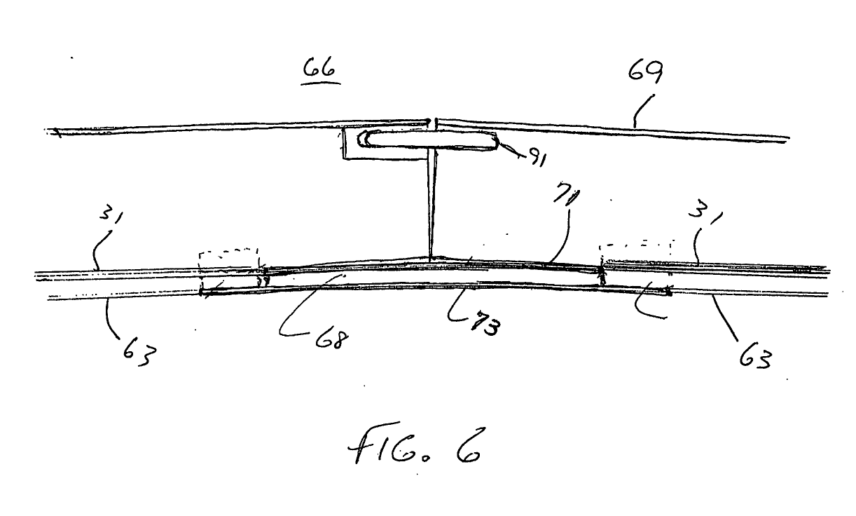

The smooth transition from the radial reversing track 16 to the topside horizontal ways 22 of lower frame 55 also minimizes the amount or length of feed end ramping necessary for applying a controlled rise laminating pressure technique as between the upper and lower conveyor belts, if desired. As is illustrated in FIGS. 5 and 6, and will be explained further below, the ramp to horizontal juncture of the upper conveyor belt frame and pressure ways 31 has a slight bend with a large radius to close the adjacent edges of the belt platens smoothly as they contact the product. Should the machine require the ability to be extended in length, this hinged front end frame assembly can be detached at this point for insertion of a frame extension. If no such requirement is anticipated, the ramp assembly may be welded directly to the frame.

The preferred embodiment has upper and lower conveyor frames 19 and 20, each consisting of a single structural steel weldment that is machined as a single unit. On a machine three to five feet wide, two “I” beams are used, both top and bottom. On the lower frame, the top of the top flange 21 is machined to accommodate a flat ground way 22 as pressure way with a side stop rail 33 for the illustrative platen roller 24. The outer edge of the bottom flange 25 of the I beam is trimmed back to clear chain links. The underside surface of the bottom flange 26 is machined flat and the top surface of the outside of the bottom flange 27 is machined to obtain the correct thickness for passing the conveyor belt assembly. The concept is to select and modify a single, available structural piece of steel to obtain the most functionality from the least amount of parts and labor.

Each of the two top frame “I” beams has the bottom outside flange edge cut back and machined for chain clearance. The top surface of the ends of the top flange 28 are machined for transition. A steel bar 29 is welded onto the outside of the web of the I beam just above the bottom flange to be machined to carry pressure rail 31. The block also carries the roller side-rail 30 for lateral restraint. This roller side-rail restraint 30 is held in place by pressure rail 31. In accordance with the concept explained above, the intent is to be able to machine the entire frame to where there is no rail adjustment needed to have a straight, flat running surface or way.

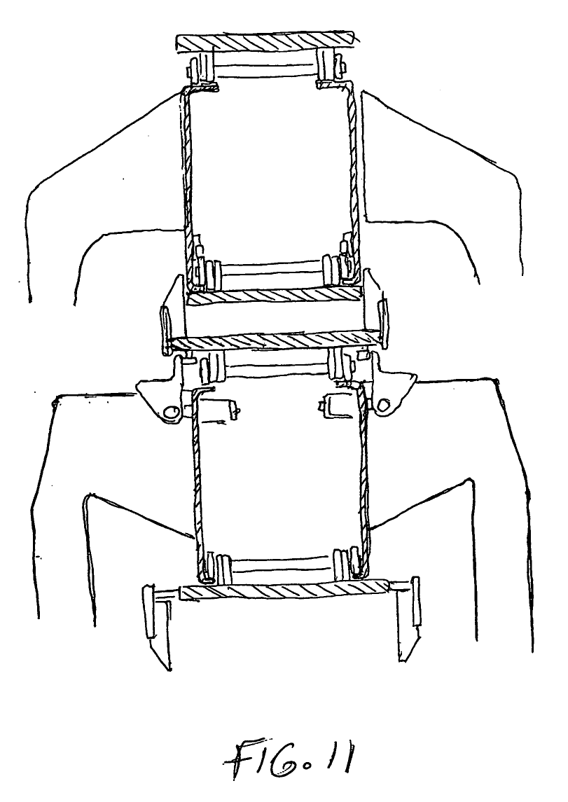

Another embodiment with a wider laminator frame uses three “I” beams for the pressure side of the belt path, with the two outside beams carrying the belt over the return path. Other embodiments with narrow frames reverse the carrying surfaces and use a channel type beam, flanges extending inward, as is illustrated in FIG. 11. The beam in these cases can be a weldment, bent section, or cut down “I” beam. As is shown, the narrow embodiment laminator chain links may be configured with a common link joint pin that goes all the way across the belt from link to link to keep the laminator narrow and the distance between links wide enough for effective engagement with the center mounted drive sprockets. A variant of this embodiment can also be driven with an extended but not full span link pin or by engaging the sprocket teeth directly into drive slots in the underside of the platens. These variations enable the machine to be quite narrow and still accommodate a center mounted gearbox.

The bottom frame can be machined as a complete weldment. Because there is internal machining on the top frame, it may be assembled after machining or machined as a complete weldment with the right welding machine and setup.

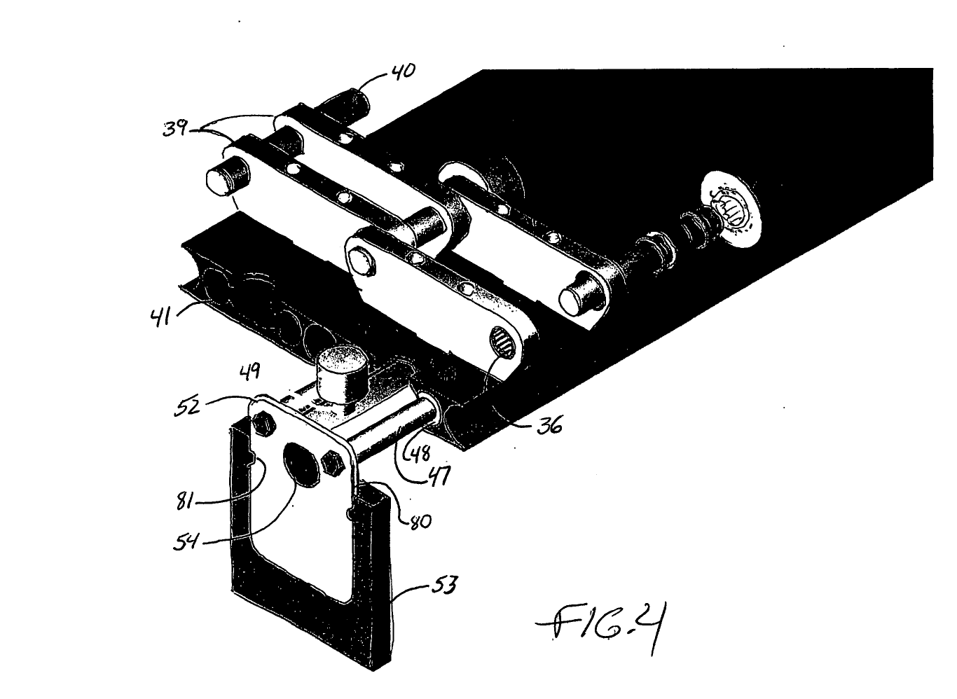

As illustrated in FIG. 2, the illustrative rollers 24 that carry the platen chain on the ways, also take the side thrust against the roller side-rails 23 and 30, to keep the chain running straight. A ball bearing, a double ball bearing, a roller bearing capable of slide thrust, or a roller and side thrust roller combined may be used for the roller function. A double ball bearing is preferred. FIG. 4 illustrates the roller/link assembly in detail.

FIG. 3 shows the platen surface of two adjacent platens as they would contact and carry the panel skin through the laminator, with a chain link and roller assembly extending below, and with a side deckle slider and plate extended out from the outboard end of the platen. FIG. 4 shows this structure from the underside. The chain links use needle bearings 36 on the pivot link plates 37-38. All chain link plates 37, 38, and 39, are precision cut from flat stock. The two inner link plates 39 have the pins 40 pressed into them. Pins 40 are pressed in a fixture that gages the spacing and the correct protrusion of the pin for roller mounting. The spacing of inner link plates 39 is coordinated to accept engagement of pin 40 between plates 39 with drive sprocket 6 of FIG. 1. The two inner link plates 39 with pins 40 are bolted to a platen as a unit. The platens assembled with inner link plates and pins are laid out in alternating fashion with unassemblied platens for further assembly into respective upper and lower laminator belts.

The two outer link plates 37, 38 have needle bearings 36 or bushings pressed into them. Each pair of outer link plates 37, 38 slide over the protruding ends of pins 40 of two inner link and are bolted to their respective unassemblied platens 41. Sealing O-rings 42 are installed on each side of the needle bearings 36 before chain assembly. The pin 40 protrudes through the inboard or roller side outer link plate 37 far enough to accommodate a belt support roller 43. A snap ring 44 goes on either end of pin 40 to retain roller 43 in place. Roller side link plates 37 have shoulders 45 to space the rollers 43 appropriately from the plate. Link plates 37, 38, 39 are fabricated from aluminum or steel. Link pins 40 are cut from linear bearing rod or hardened steel rod.

To break the chain, any set of the outer link plates 37, 38 can be unbolted from a platen 41, the snap ring 44 and roller 43 removed from link pins 40, and the outer link plates 37, 38 removed.

Another embodiment of the chain link mechanism uses a single center link instead of two inner link plates 39, requiring a different drive sprocket configuration. In some embodiments, one or more sprockets drive the platen by means of a hole or holes milled in the bottom of each platen. The holes receives a pin or tooth on the sprocket. This arrangement works well for narrow laminators. Yet another drive configuration aligns and engages an extension of the link pin on the opposite side of the link from the roller.

Referring again to FIGS. 3 and 4, platens 41 forming the conveyor belt are aluminum extrusions with a hollow core which has a modified dog bone profile 47. Two ¾ round elongate plastic extrusions 48, are installed inside the respective ends of the core platen profile 41 as slider bearings. A second aluminum extrusion 47, is configured to slide smoothly into the platen core/plastic bearing assembly; one in each end of the platen. End holes are drilled and tapped in the center of each round section of the slider dog bone extrusion 47. A cam follower 49 is installed near the outboard end on the underside of the extrusion to control slider position as the platen is advanced through the laminator. The outboard end of the slider is machined flat, and a plate 52 is mounted on the end of it, so as to be outboard of the platen and perpendicular to the platen surface when the slider extrusions 47 are assembled with their respective platens 41.

The platen 41 and end slider extrusions 47 are the components of the sliding deckle. The deckle 52 is a vertical plate that bolts to the slider 47. The deckle 52 is machined with an edge step 80. Step 80 has a slight intrusion 81 on each side near the bottom of deckle 52. A mold profile block 53 slides over deckle 52. A hole 54 in the deckle plate allows the mold plate to be pried off the deckle plate 52.

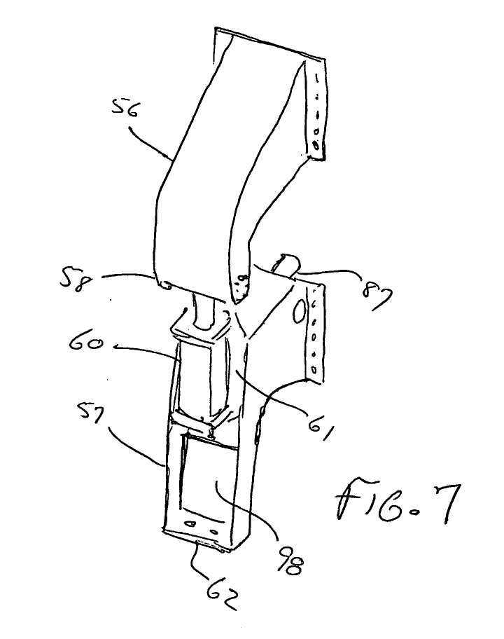

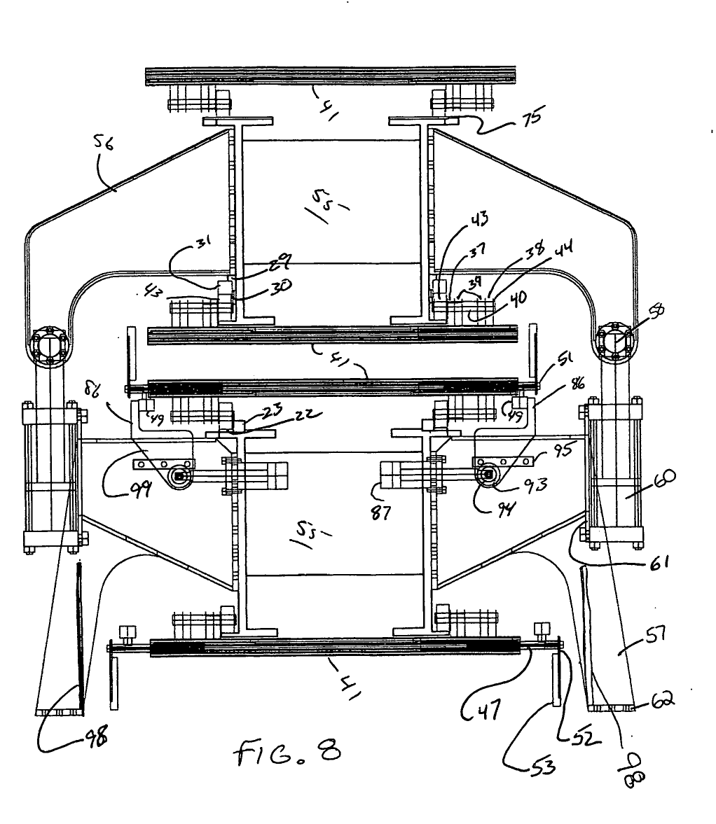

Referring to FIGS. 5-8, the laminator frames 55 have two supports under the main section, (only one is visible in the figures), and a further front section support under the hinged front end section, each consisting of outriggers 56 and legs 57. To facilitate tilting the upper frame for setting the laminator at an angle to form a tapered product, the axis of the attach point 58 of cylinders 60 on main section supports should be aligned with or near the plane of the pressure side face of the belt as is apparent in FIG. 8, so that lateral displacement of the upper conveyor belt is minimal with respect to the lower belt.

Cylinders 60 are mounted to plates 61 on legs 57. The plates can flex slightly to accomodate the slight change in side to side spacing and angle as the laminator frame is tipped a few degrees for making tapered product. Legs 57 are fabricated with steel plates that flex to accommodate thermal expansion of the frame. The center support assembly legs 57 have a web 98 that extends down to foot 62. This reinforced center leg causes thermal erosion in the frame length to be distributed in both directions along the frame, distributing the deflection inflected on the other supports. The preferred embodiment has a total of three supports, but the number of supports is determined by frame length and other embodiments may have more. The upper attach point 58 of cylinder 60 is a pivot point, preferably a tight trunion type of attachment. The pivot axis is parallel to the run of the laminator conveyor, to accomodate tilting of the laminator.

The cylinders 60 are the only structural connections between the top and the bottom sections of the laminator framework. They are longitudinally rigid connections that hold the top belt accurately located over the bottom belt. Cylinders 60 require a large piston and rod to resist this side load or longitudinal thrust. Cylinders 60 have electronic extension positioning. This enables the laminator thickness and angle of taper side to side to be easily and quickly set and held in an exact position. The cylinder lengths can be set the same to run uniformly thick, core foam panels or other laminate products, or set at different lengths on opposite sides of the frame, to make tapered product. Electronic cylinder control eliminates the use of traditional jacks or manually installed spacer blocks to control thickness.

Conforming to good practice, the abutting ends of all flat ground pressure and carrier rail sections are cut at an angle other than perpendicular to the running surface in order to avoid the click of the rollers over a butt joint.

Rolling bank can be experienced with production of either smooth or irregular surfaced panels such as egg crate or corrugated panel surfaces. To ameliorate the problem of rolling bank rise, there is incorporated into the preferred embodiment a top frame pivotal section that is adjustable by its support assembly so as to be inclined downward parallel to the effective ramp angle of the expanding foam as it rises while being advanced into the laminator. Using this feature and operating technique, the rolling bank is substantially eliminated and the foam cells are able or more likely to remain oriented and cured to the preferred egg shape, in a vertical orientation, so as to produce a better quality foam layer in the panel from a continuous belt laminator.

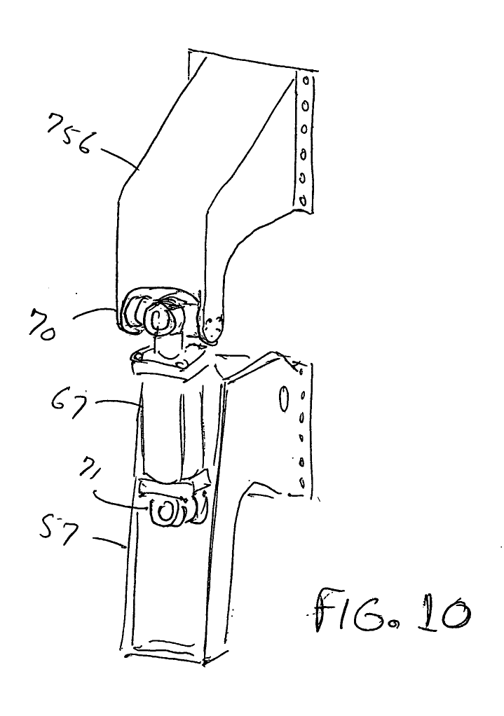

Referring in particular to FIGS. 5, 6 and 10, the laminator frame can alternatively be constructed with a plate hinge joint 66 in the top frame to provide the adjustable ramp capability at the front end of the machine for conducting laminating operations using a controlled rise technique. The front end support cylinders 67, work independently of the center and drive end support cylinders 60 when operating the hinged or pivotal section 69 of the top frame 55. This allows the pivotal top section angle, which with the level bottom frame 55 forms the throat of the laminator, to be set independently of the remainder of the top frame 55 angle. This is an important and novel feature or aspect of the invention, the purpose of which is to control foam rise at the feed end of the process as the top skin is brought into contact with the expanding foam core. The bend radius in the pressure rails 31 necessary to accommodate this hinged section 69 is intentionally gradual so as to minimize the required edge gap between platens resulting from the inside bend in the belt track. Specifically, the gap is required because the platen surface is offset outwardly from the chain link hinge line by a measurable distance, so that a concave chain path necessarily results in a squeeze to the platen spacing as compared to a straight line path or frame end reversal in direction. The pressure side bend of the conveyor belt at the ramp transition, while gradual and minor, does require accommodation in platen spacing in the form of a slight gap, which will be narrowed to nearly nothing as the platens pass through the transition area. Large platen gaps can cause lines in the final product; so a large radius transition is used to enable use of a very small platen gap. Platen gap lines in the product can be further minimized, if desired, by adapting the platen edge configuration to provide for interlocking or meshing fingers or teeth so that the gap is not continuous.

The length of the hinged section 69 is governed by the foam system used, the speed of the laminator and the desired product, but is typically approximately 10 feet in length for contemporary products and machine speeds. The foam will rise to its full height by the time this distance is covered.

Referring again to FIGS. 5-8, in a laminator machine having a twin I beam frame as described for the preferred embodiment, the upper conveyor belt main section I beams of frames 55 are squared off and butt uniformly with the matching I beams of the ramp extension hinged section 69. The bottom or carrier rail flange 63 of each of the beams is cut or ground away or removed for a suitable length, five feet on each beam in the preferred embodiment, and the web centers of the I beams are further removed for about four feet of length on each beam in the preferred embodiment, in height about that of the link roller 24 diameter and pressure rail 31 height. About the innermost one foot of the exposed I beam web edge on both main section and ramp section beams is reinforced with a steel plate on the inboard side of the web.

The pressure rail 31 is replaced in the hinged joint 66 with a pressure rail plate 71 about eight feet long and spanning both I beams and extends outboard of each beam in width to fulfill its function as the continuation of the top pressure rail 31 for the chain link rollers through the hinged joint region. Roller rub rails 68 are positioned below the pressure rail plate approximately aligned with the I beam webs, in the form of a pair of square section UHMW strips.

The removed flange 63 material from the bottom of the I beams that functioned as a carrier rail, is replaced with a metal hinge plate 73 that spans both I beams of both sections for the full length of the exposed web, here about 10 feet, and is secured to the reinforced web edges at its two ends. The ramp extension 69 is supported mainly by the forward support cylinders 67, but is constrained to a bending and tilting motion by its connection through the hinge plate 73 to the main section of the conveyor, whenever the foreward support frame is vertically adjusted. The metal hinge plate 73 functions as a large, flexible spring plate hinge, arching away from the I beams of frame 55 over an effective length of about eight feet with a uniformly large radius when the forward support frame is adjusted lower to tilt the ramp extension downward. The extended side edges of hinge plate 73 function as the carrier rail over the length of the hinge plate. The large radius bend of the hinge plate provides a gentle transition region between the linear portions of the main section and the ramp extension 69 for the upper conveyor belt.

The two plates and rub rail strips are attached together with recessed fastners through slotted holes to allow for limited fore and aft slippage between these components occurring with flexure of the flexible hinge plate. The pressure rail 31 to 71 joints are tight as between the pressure rail plate 71 and the pressure rail 31 components when the ramp extension angle is zero. The centerpoint of the radius of curvature for ramp extension 69 is well below the hinge plate, so the pressure rail plate 71 curvature introduces a gap in the pressure rail at the plate ends proportional to ramp angle. Interlocking fingers or a diagonal joint here, as in all other rail joints, provides a smooth joint for the link rollers 43 on the pressure rail, irrespective of ramp angle and relative gap.

An upper yoke or slip fitting 91 is fabricated to help maintain a corresponding uniform radius bend to keep the return track tops of the abutting beam end pairs in vertical and horizontal alignment throughout the range of motion of the hinge plate. Again, diagonal joints or finger joints configured with a slight radius assures link roller transition over the “top” of the bend. When the ramp extension is placed at a horizontal position with no ramp angle, the square beam ends meeting in abutting fashion tend to assure the hinge plate is fully extended and flattened.

In other embodiments, the plan form of springe hinge plate 73 may vary; particularly in machines having more than two main beams and chains. The hinge plate may be in the form of an individual strap or elongate plate or other shape for each abutting pair of beams. In a four beam design, it may be a pair of hinge plates where the first plate spans and connects the first two adjacent beams and the second plate spans and connects the second two adjacent beams.

In another varation, the pressure rail plate 71 can be configured to be the hinge plate rather than or in combination with the carrier rail hinge plate 73.

The lower conveyor belt may likewise be configured with a flexible hinge ramp section, providing double the angular range of ramp effect and symmetry as between upper and lower conveyor belt paths and platen motion.

Referring to FIG. 8, platens 41 can be heated using the frame of the machine as a heat transfer medium. A water radiator can be installed in the front end of the laminator so that air can be blown through it to be heated, and down the length of the top and bottom sections of the laminator to transfer heat to the metal components.

Referring to FIG. 4, the undersides of platens 41 are configured with an open center slot 83 to allow the hot air to circulate into the platen core. A semicircular slot 84 in each end of the underside of the bottom platens is for accepting cam follower 49 when the side deckle is fully retracted for close forming. If extra width correction is desired in the product, the sliding deckle system may be changed to a split platen sliding system. A split platen is known in the art, but in the instant invention it can be provided with the same components that are used for the moving deckle. A center slide similar to extrusion 47 is attached directly to the chain links, and the platen is divided into two platens, which slide along the fixed center slide. The platens are slotted on the underside to accomodate the link attachment to the slider. The deckles and cam followers are then attached directly to the outboard ends of the platens. The chain links are attached after the platens and center slides are assembled, unless the platen slots are open on at least one end.

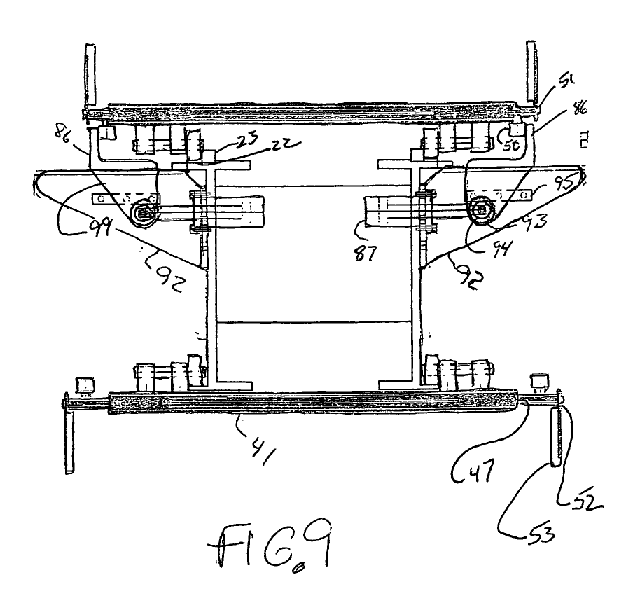

Referring to FIGS. 8 and 9, deckle rails 86 control the movement of the deckles. Each deckle rail 86 sits on legs 64 and lookouts 92. The deckle rails are moved horizontally in and out with jacks or hydraulic accuators 87 in the legs and lookouts. Because of the side pressure required to contain the expanding foam laminating process with the side deckles, the deckle rails 86 need to be supported more frequently than just at the main supports or legs of the frame. Therefore, lookouts 92, which are additional support structures illustrated in FIG. 9, are used to support the deckle rails 86 between the support legs 57 illustrated in FIG. 8. The lookouts have the same top level alignment as the top of the support legs, and allow the angle iron deckle rail 86 to slide back and forth on the top faces of the legs and lookouts so as to retract the side deckles by their cam followers 49. Lookouts 92 contain the same jack or accuator 87 as the legs 57 of FIG. 8, plus the same trunion 93, mounting geometry, cam followers 94, and cam rails 95. Electronic control of deckle rail 86 positioning contributes to automated control of the laminator. The side deckle is mounted and works in conjunction with the lower conveyor belt in the preferred embodiment, and so is not affected by the ramp angle of the hinged front section.

If a hydraulic system is used to control the adjustable aspects of the laminator, such as panel thickness, taper, ramp angle, and side deckle operation, an overpressure relief system must be incorporated to prevent possible damage to the machine, product or operator caused by an excessive build up of pressure by the expanding foam. The system requires a valve or equivalent in the hydraulic pressure line that would shut off or relieve the pressure line to the respective cylinders. This applies to alternative embodiments as well. For example, if jacks are used to support and space the frames, hydraulic cylinders may be used to tie down the top frame to the bottom. The relief valves on the hydraulic cylinders allow for the release of excessive pressure thereby preventing injury to the operator, to the machine or to the product. However, damage from excessive pressure is not as great a danger in the case of the side deckle system as this can be ameliorated by other means, so jacks can be used for both the push and pull if desired.

Deckle rail 86 is straight and parallel to the run of the platens. Large angle iron stock may be used. The rail must be installed in as straight an alignment with the frame as possible. A preferred method of construction, consistent with the overall approach, is to mount the angle iron securely in a reference alignment, and machine the bearing surface with precision milling equipment mounted on a platen to achieve precise alignment of the bearing surface to the frame. The milling equipment can then travel the length of the machine and give a true edge to the rail. The milling process can be simplified by mounting a soft bearing face on the rail such as UHMW plastic, which can be easily replaced and re-milled when required. The lead in or out sections of the rail should be of harder material to improve wear. Aluminum may be used but may shale in hard work areas.

The deckle rail 86 is bent outward for deckle cam follower lead in at the front of the machine where the deckles track in from an extended position. A similar bend in the deckle rail must be arranged on the back of the machine to allow the deckles to track out at the end of the pressure path. As the deckle may be inset into the edge of the laminate, it must be extracted before the platen reaches the drive sprocket or curved section of the belt, lest the newly minted panel be damaged. An additional rail is mounted on the main deckle rail or on the laminator, configured to push the deckles away from the platens at the end of the pressure path. A similar rail is provided at the front of the machine for when the laminator is running in reverse.

Many laminators use either 2 or 5 chains to carry the platens. A preferred embodiment of the invention utilizes two. A problem with two-roller systems is that the panel produced may be thicker in the center than at the edges, rather than being uniformly thick. This is often due to platen deflection in the center between the support rails. One way to reduce this is to locate the chains with approximately a 1-2-1 ratio of relative position across the platen for load balancing across the platen. For example, on a four foot platen, the chain links would be attached at one (1) foot from each side, and two (2) feet from each other. The link spacing may need to be adjusted to be closer to the outside edges because the foam load on the deckle adds a cantilever effect on the end loading of the platen.

A common solution to the thick center problem on a five chain machine is to adjust the three center rails higher, raising the center about 0.030 inches above the outside. This works to make thin flat product. On a two chain machine of the invention, one can truss, or machine the platens to have a no-load crown which deflects under load to produce uniform laminate. One means of achieving this truss effect is to use a single rod and block jack. The rod goes through the link or up through the platen over the link. The link can be made taller and the rod extended through from the outside, be threaded and tightened from the outside to hold the block in place, eliminating need for a jack. Another embodiment uses a roller chain with an additional support beam in the center.

The inventive subject matter pervades the overall machine design, being readily apparent in both the whole and many of the numerous details. The present invention has been particularly shown and described with respect to certain preferred and alternate embodiments and combinations of features. However, it should be readily apparent to those of ordinary skill in the art that various changes and modifications in form and details may be made without departing from the spirit and scope of the invention. The description and figures are to be regarded as illustrative in nature, and not exhaustive of the scope of the claims that follow.

For example, there is within the scope of the invention a laminator as described above, but with a deckle system consisting of a left side (or right side) deckle system operating off the platens of the lower conveyor belt, with or without an opposite side deckle system operating off the platens of the upper conveyor belt. The symmetry of this arrangement will be apparent to those skilled in the art, and may have benefits in the form of common components and operating flexibility.

Other examples of the invention include a continuous laminator for the manufacture of foam core panels consisting of upper and lower frames upon which run respective top and bottom conveyer belts, each belt driven by at least one drive sprocket coupled to a floating gearbox and motor contained within its respective frame, at least one conveyor belt having transverse platens connected by chain link assemblies, with the platens configured at outboard ends with side deckles.

The platens have a hollow core with an open end. The side deckles have a sliding component conforming in cross section to the hollow core and are partially inserted there within. The outboard end is configured with an end plate and an underside cam follower. The laminator has a deckle rail system for engaging the cam followers for extending and retracting the end plate with respect to the platen when the conveyor belt is in motion.

The chain link assemblies are chain link, pin and roller assemblies, and the top and bottom frames have pressure rails and return rails upon which the rollers bear.

Another example of the invention is a continuous laminator for the manufacture of foam core panels having upper and lower frames with carrier rails and pressure rails upon which run respective top and bottom conveyer belts, the conveyor belts having transverse platens connected by chain link, pin and roller assemblies, the upper frame further configured with a hinge plate joint connecting a main section and an adjustable front end section whereby the throat of the laminator can be partially closed for applying a controlled rise to the foam core from the front end to the hinge plate joint.

The hinge plate joint may be a hinge plate replacing a section of upper frame carrier rail and connecting a front end section to a main section of the upper frame. Or the hinge plate joint may have a hinge plate replacing a section of upper frame pressure rail and connecting a front section to a main section of the upper frame. Or it may be a hinge plate assembly replacing a section of upper frame pressure rail and carrier rail and connecting a front section to a main section of the upper frame.

What is claimed is:

1. A continuous laminator for the manufacture of foam core panels comprising:
upper and lower frames upon which run respective top and bottom conveyer belts, each said belt driven by at least one drive sprocket coupled to a floating gearbox and motor contained within its respective said frame, at least one said conveyor belt comprising transverse platens connected by chain link assemblies, said platens configured at outboard ends with side deckles.

2. The continuous laminator of claim 1 wherein said platens have a hollow core with an open end, said side deckles comprise a sliding component conforming in cross section to said hollow core and partially inserted there within and to which outboard end is attached an end plate and an underside cam follower, and said laminator further comprising a deckle rail system for engaging said cam followers for extending and retracting said end plate with respect to said platen when said conveyor belt is in motion.

3. The continuous laminator of claim 2, said end plate being configured to accept attachment of a molding head.

4. The continuous laminator of claim 2, said hollow cores being configured with slider bushings for said sliding components.

5. The continuous laminator of claim 2, said chain link assemblies comprising chain link, pin and roller assemblies, said top and bottom frames configured with pressure rails and return rails upon which said rollers bear.

6. The continuous laminator of claim 7, said at least one drive sprocket being configured at the back end of said frames for engagement with said pins of said chain link, pin and roller assemblies.

7. The continuous laminator of claim 6, each said platen of each said conveyor belt configured with two said chain link, pin and roller assemblies in a uniformly spaced arrangement, said at least one drive sprocket being two drive sprockets for each said conveyor belt arranged on a common drive shaft extending on either side from said gearbox and motor with a corresponding uniformly spaced arrangement such that said sprockets engage said pins for driving said conveyor belts, said drive shaft configured for left and right side belt tension control.

8. The continuous laminator of claim 2, said deckle rail system being attached to said lower frame and having actuator means for horizontal positioning of a deckle rail for engagement with said cam followers when said lower conveyor belt is in motion.

9. The continuous laminator of claim 6, the front end of each said frame configured with 180 degree reversing tracks carrying said rollers from said return track to said pressure track.

10. The continuous laminator of claim 1 wherein said platens comprise split platens having hollow cores of common cross section with an open inboard end and a cam follower on the underside at the outboard end, said split platens being slidingly connected by a sliding component conforming in cross section to said hollow cores, said side deckles comprising an end plate attached to the outboard end of said split platens, said laminator further comprising a deckle rail system for engaging said cam followers for extending and retracting said split platen and end plate with respect to said sliding component.

11. A continuous laminator for the manufacture of foam core panels comprising:
upper and lower frames with carrier rails and pressure rails upon which run respective top and bottom conveyer belts, said conveyor belts comprising transverse platens connected by chain link, pin and roller assemblies, said upper frame further comprising a hinge plate joint connecting a main section and an adjustable front end section whereby the throat of said laminator can be partially closed for applying a controlled rise to the foam core from the front end to the hinge plate joint.

12. The continuous laminator of claim 11, said hinge plate joint comprising a hinge plate replacing a section of upper frame carrier rail and connecting a front end section to a main section of said upper frame.

13. The continuous laminator of claim 11, said hinge plate joint comprising a hinge plate replacing a section of upper frame pressure rail and connecting a front section to a main section of said upper frame.

14. The continuous laminator of claim 11, said hinge plate joint comprising a hinge plate assembly replacing a section of upper frame pressure rail and carrier rail and connecting a front section to a main section of said upper frame.

15. The continuous laminator of claim 11, each said belt driven by at least one drive sprocket coupled to a floating gearbox and motor contained within its respective said frame at the back end of said frame, said bottom belt comprising transverse platens configured at outboard ends with side deckles.

16. The continuous laminator of claim 15 wherein said platens have a hollow core with an open end, said side deckles comprise a sliding component conforming in cross section to said hollow core and partially inserted there within and to which outboard end is attached an end plate and an underside cam follower, and said laminator further comprising a deckle rail system for engaging said cam followers for extending and retracting said end plate with respect to said platen when said conveyor belt is in motion.

17. The continuous laminator of claim 16, each said platen of each said conveyor belt configured with two said chain link, pin and roller assemblies in a uniformly spaced arrangement, said at least one drive sprocket being two drive sprockets for each said conveyor belt arranged on a common drive shaft extending on either side from said gearbox and motor with a corresponding uniformly spaced arrangement such that said sprockets engage said pins for driving said conveyor belts, said drive shaft configured for left and right side belt tension control.

18. The continuous laminator of claim 17, said end plates being removably configurable with a molding head.

19. A continuous laminator for the manufacture of foam core panels comprising:
upper and lower frames upon which run respective top and bottom conveyer belts, each said belt driven by at least one drive sprocket coupled to a floating gearbox and motor contained within its respective said frame, at least one said conveyor belt comprising transverse platens connected by chain link assemblies, said platens configured at outboard ends with side deckles, wherein said platens have a hollow core with an open end, said side deckles comprise a sliding component conforming in cross section to said hollow core and partially inserted there within and to which outboard end is attached an end plate and an underside cam follower, and said laminator further comprising a deckle rail system for engaging said cam followers for extending and retracting said end plate with respect to said platen when said conveyor belt is in motion, said upper frame further comprising a hinge plate joint connecting a main section and an adjustable front end section whereby the throat of said laminator can be partially closed for applying a controlled rise to the foam core from the front end to the hinge plate joint.

20. The continuous laminator of claim 19, said hinge plate joint comprising a hinge plate assembly replacing a section of upper frame carrier rail and pressure rail and connecting a front end section to a main section of said upper frame.
